(19) United States
(12) Patent Application Publication
(10) Pub. No.: US 2022/0009763 A1
(43) Pub. Date: Jan. 13, 2022

(54) SmarTack

(71) Applicant: Brandee Lynn Gallagher, Sanger, TX (US)

(72) Inventor: Brandee Lynn Gallagher, Sanger, TX (US)

(21) Appl. No.: 16/922,207

(22) Filed: Jul. 7, 2020

(51) Int. Cl. B68B 5/06

(52) U.S. Cl. CPC B68B 5/06; F16B 2001/0028

(57) ABSTRACT

The SmarTack design with interchangeable inlays, or “faces,” was born out of the need to conserve money coupled with the desire of staying up to date with style. No other product has been found up to this point. The SmarTack product line allows the user to quickly, easily and inexpensively change the look of their tack, as frequently as they desire. I developed SmarTack with the goal of providing something that can be purchased “on a teacher's budget” as I am a teacher and have had to say “no” on several occasions that my daughter wanted new horse tack just because she wanted to change the style. I could not justify spending hundreds of dollars on a whim. However, if something like SmarTack had existed, it would certainly have been something I could have done financially.

### BRIEF SUMMARY OF THE INVENTION

The SmarTack line of tack has two separate pieces, both of which require a utility patent.

### 1) The SmarTack Base

The SmarTack base (ie. halter, breast collar, spur strap, wither strap or head stall) is fitted with an industrial strength, low-profile, acrylic adhesive hook strip, both glued and stitched into the base. The acrylic adhesive is an important feature of this design as it withstands heat and weather elements far better than other adhesives we have tried, such as rubber. Each SmarTack base, with its hook feature can readily accept “Smart Tack” faces with a compatible loop option.

### 2) The SmarTack Inlays

A low profile, industrial strength, acrylic adhesive loop is attached to the back side of leather and vinyl designs to create a “Velcro” inlay that can be quickly and easily affixed to any SmarTack base.

### BRIEF DESCRIPTION OF THE DRAWINGS

FIG. 1 shows the headstall/bridle pieces: two cheek pieces, a brow band, and two straps to assemble the pieces together. The two cheek pieces and the brow band detail a piece cut out of the center area. This area is where the Velcro hook is affixed. Also in this figure, you can see items 2 and 3 show a more detailed look at the SmarTack inlay items that will go into the the cut out area and affixed with its Velcro loop mate.

FIG. 2 shows the breast collar pieces: two folding “arm” designs that join together with a center plate buckle. Each arm has a cut out detail that you can clearly see in the drawings. This cutout is where the acrylic adhesive hook is affixed and sewn. I did not have the “inlays” drawn for this figure, but it would follow the same idea as FIG. 1.

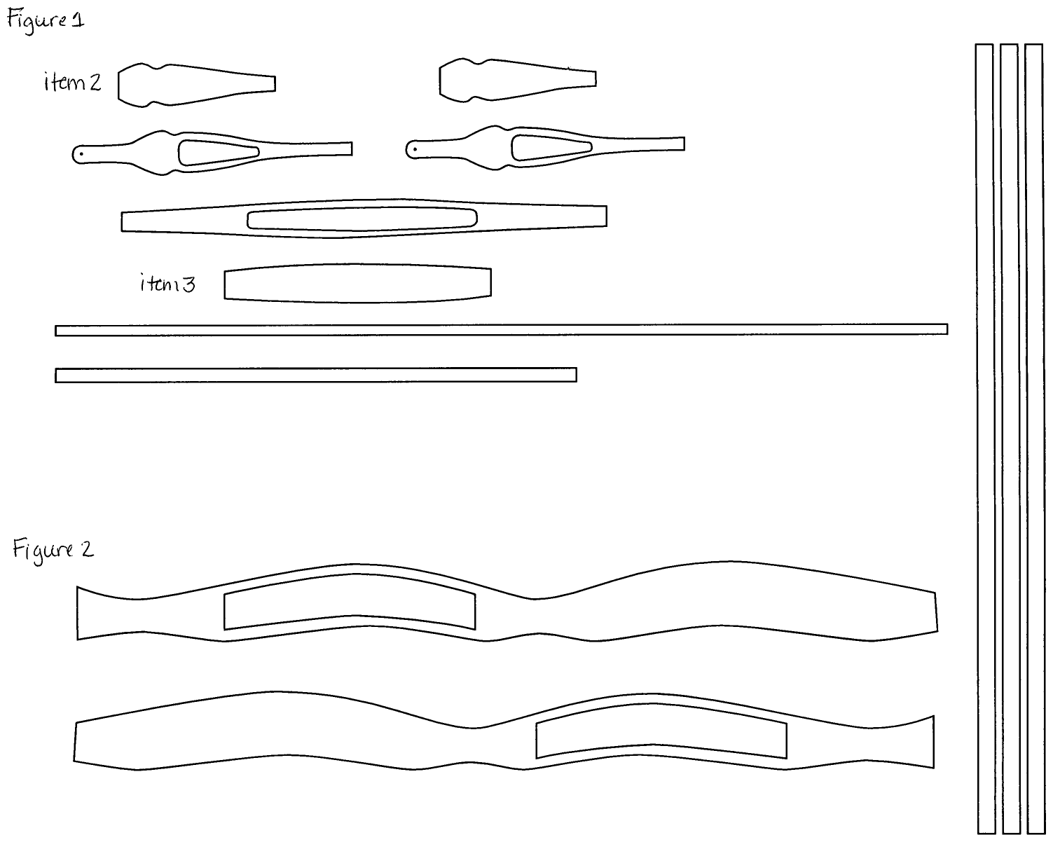

### DETAILED DESCRIPTION AND BEST MODE OF IMPLEMENTATION

While the shape/pattern/style of the design might change, the utility of the SmarTack base and inlays will not. All SmarTack bases will have a low-profile, adhesive hook affixed to it. All SmarTack inlays will be adhered to a low-profile, adhesive loop for easy insert and removal of the inlays, or “faces” and bases.

After several prototypes, it has been determined that an acrylic adhesive hook and loop are the best materials to be used in these items as the acrylic adhesive can withstand temperature differences and can hold up against the elements common in horseback riding (ie. Sweat, dirt, frequent movement, etc).

To date we have made two versions of the breast collar, two versions of the headstall/bridle and two versions of a halter showing different designs/styles. This SmarTack feature, however, can be created with any number of horse tack items from harnesses through spur straps, helmets, and even hats or saddles. We hope to expand in to some of those areas in the future.

What is claimed is:

1. No product similar to the SmarTack line exists.

2. The SmarTack line allows the user to quickly, easily, and inexpensively change the look of their horse tack and equipment, without the need to purchase additional tack items.
